(19) United States
(12) Patent Application Publication
(10) Pub. No.: US 2014/0140797 A1
(43) Pub. Date: May 22, 2014

(54) TROLLEY FOR STORAGE IN A VEHICLE

(71) Applicant: HOWE RENOVATION (YORKS) LIMITED, Barton upon Humber (GB)

(72) Inventor: Anthony Richard Howe, Barton upon Humber (GB)

(73) Assignee: HOWE RENOVATION (YORKS) LIMITED, Barton upon Humber (GB)

(21) Appl. No.: 14/133,214

(22) Filed: Dec. 18, 2013

Related U.S. Application Data
(63) Continuation of application No. PCT/GB2012/000265, filed on Mar. 23, 2012.

(30) Foreign Application Priority Data
Jun. 24, 2011 (GB) 1110832.1

(51) Int. Cl. B60P 1/64

(52) U.S. Cl. CPC B60P 1/6418
USPC 414/498

(57) ABSTRACT

The present invention relates to a vehicle storage device. A trolley is provided having folding legs with wheels which move from a first in use position with the legs supporting the trolley for wheeled movement along the ground, to a second storage position with the legs folded adjacent the trolley. A housing is provided for mounting in a vehicle to accommodate the trolley with legs in the second position. Goods can be placed in the trolley in one location and the trolley can be used to transport the goods with its legs in the first position to the vehicle where the trolley legs can be placed in a second storage position and the trolley placed in the housing whilst still supporting said goods, and the trolley can then be removed from the vehicle with its legs placed in the first position to transport goods to a second location.

The present invention relates to a trolley with a vehicle storage device.

It is often desirable to transfer goods from building to a vehicle and vice versa. For example when shopping, a trolley is often used to take goods from a shop to be unloaded into a vehicle. The vehicle then travels to a shopper's house where the goods need to be unloaded manually. It can be time consuming and labour intensive unloading goods into a vehicle from a trolley and then unloading manually goods from a vehicle into a house.

Tradesmen too face similar problems of having to load a vehicle with tools in one location and off load them manually at another location.

The invention seeks to provide a solution to the problem of loading and unloading goods manually in and out of buildings into vehicles and vice versa.

According to the present invention there is provided a trolley with a vehicle storage device comprising:
a) a trolley having folding legs with wheels which move from a first in use position with the legs supporting the trolley for wheeled movement along the ground, to a second storage position with the legs folded adjacent the trolley, said trolley providing storage for goods, and
b) a housing for mounting in the vehicle to accommodate the trolley with legs in the second position,
   in use the goods can be placed in the trolley in one location and the trolley can be used to transport the goods with its legs in the first position to the vehicle where the trolley legs can be placed in a second storage position and the trolley placed in the housing in the vehicle whilst still supporting said goods, and the trolley can then be removed from the vehicle with its legs placed in the first position to transport goods to a second location.

Preferably a support guide is provided to guide and support the trolley with its legs in the second position away from the housing out of the vehicle whereby its legs can he placed in the first position to support the trolley off the ground. Preferably a pair of guide wheels is provided on the trolley to ride on a pair of rails forming said support guide.

An embodiment of the invention will now be described with reference to the accompanying drawings in which:

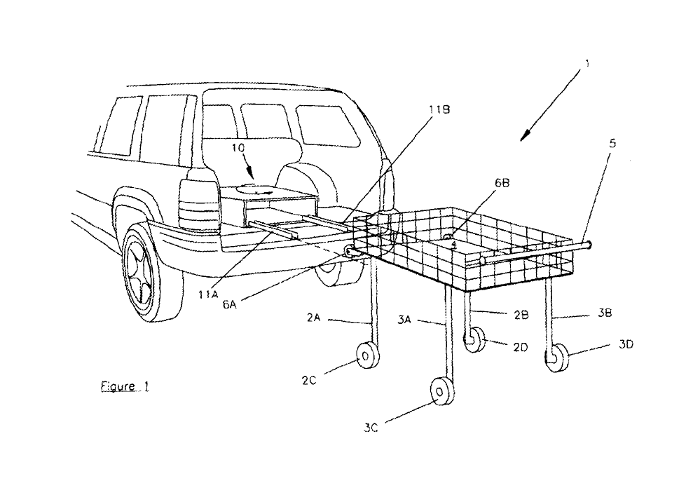

FIG. 1 shows a perspective view of a trolley with legs in the first position adjacent a vehicle, and

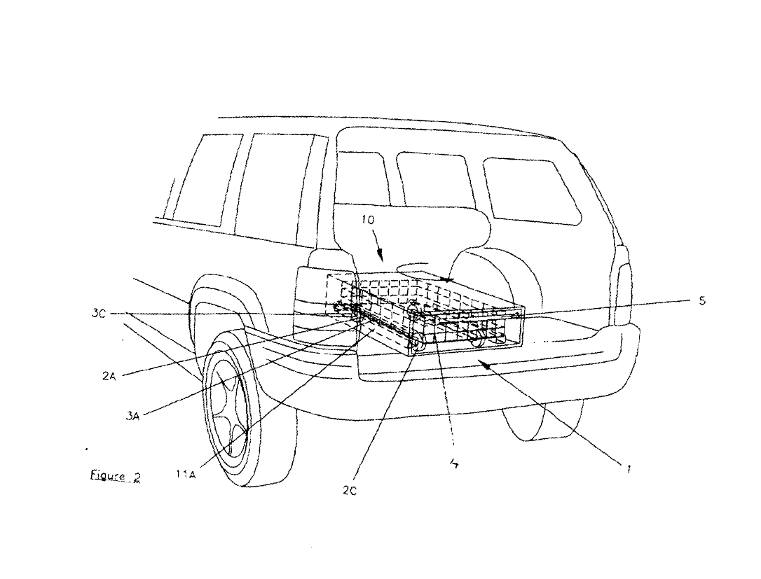

FIG. 2 shows a perspective view of a trolley with legs in the second position stored in the housing.

Referring to the drawings there is shown a trolley with a vehicle storage device 1. Trolley 1 has two pairs of folding legs 2A,2B,3A,3B with wheels 2C,2D,3C,3D which move from a first in use position with the legs supporting the trolley for wheeled movement along the ground (see FIG. 1), to a second storage position with the legs folded adjacent the trolley (see FIG. 2). Trolley 1 has a basket 4 providing storage for goods, and push handle 5. Trolley 1 also has a pair of guide wheels 6A,6B.

A housing 10 is provided for mounting in the rear of the vehicle to accommodate the trolley with legs in the second position. Housing 10 has a pair of rails 11A,11B which slide in and out of the housing 10. Rails 11A,11B receive guide wheels 6A,6B. Rails 11A,11B and guide wheels 6A,6B guide and support the trolley with its legs in the second position away from the housing out of the vehicle whereby its legs can be placed in the first position to support the trolley off the ground. Rails 11A,11B could be supported by supports if required.

Housing 10 can rotate so that it can sit sideways to the length of the vehicle to improve storage space in the rear of the vehicle when the trolley 1 is not in use.

In use the goods can be placed in the trolley 1 in one location (e.g. a shop) and the trolley 1 can be used to transport the goods in basket 4 with its legs in the first position to the vehicle (FIG. 1) where the trolley legs can be placed in a second storage position and the trolley placed in the housing in the vehicle (see FIG. 2) whilst still supporting goods in basket 4. The trolley 1 can then be removed from the vehicle with its legs placed in the first position to transport goods to a second location (e.g. the user's house).

The invention may take a form different to that specifically described above.

Further modifications will be apparent to those skilled in the art without departing from the scope of the present invention

1. A vehicle storage device comprising:
a) a trolley having folding legs with wheels which move from a first in use position with the legs supporting the trolley for wheeled movement along the ground, to a second storage position with the legs folded adjacent the trolley, said trolley providing storage for goods, and
b) a housing for mounting in the vehicle to accommodate the trolley with legs in the second position, said housing being rotatable,
in use the goods can be placed in the trolley in one location and the trolley can be used to transport the goods with its legs in the first position to the vehicle where the trolley legs can be placed in a second storage position and the trolley placed in the housing in the vehicle whilst still supporting said goods, said housing can be rotated in the vehicle to a preferred storage position, and the trolley can then be removed from the vehicle with its legs placed in the first position to transport goods to a second location.

2. A vehicle storage device according to claim 1, wherein a support guide is provided to guide and support the trolley with its legs in the second position away from the housing out of the vehicle whereby its legs can be placed in the first position to support the trolley off the ground.

3. A vehicle storage device according to claim 2, wherein a pair of guide wheels is provided on the trolley to ride on a pair of rails forming said support guide.

4. A vehicle storage device according to claim 1, wherein the trolley has a basket providing storage for goods.

5. A vehicle storage device according to claim 1, wherein the trolley has a push handle.

6. A vehicle storage device according to claim 1, wherein the housing has a pair of rails slidably mounted to the housing.

7. A vehicle storage device according to claim 6, wherein the pair of rails receive a plurality of guide wheels mounted to the trolley.

8. A vehicle storage device according to claim 1, wherein the housing is rotatable within a horizontal plane, such that the housing can be rotated within the vehicle so that the housing can sit sideways to the length of the vehicle.

9. (canceled)
